(19) United States
(12) Patent Application Publication
(10) Pub. No.: US 2009/0284776 A1
(43) Pub. Date: Nov. 19, 2009

(54) PROCESS AND APPARATUS FOR DOUBLE-FACE INK-PRINTING CANVASES FOR ADVERTISING LIGHT BOXES

(76) Inventor: Gang SHI, Shanghai (CN)

Correspondence Address: MATTHIAS SCHOLL, 14781 MEMORIAL DRIVE, SUITE 1319, HOUSTON, TX, 77079, US

(21) Appl. No.: 12/511,173

(22) Filed: Jul. 29, 2009

Related U.S. Application Data
(63) Continuation of application No. PCT/CN2007/000317, filed on Jan. 29, 2007.

(51) Int. Cl. H04N 1/60

(52) U.S. Cl. 358/1.9

(57) ABSTRACT

The present invention provides a process and apparatus for double-face ink-printing canvases for advertising light boxes. The process includes: disposing a print head at a side of an ink print workbench, an unprinted face of a reverse side of the canvas facing to the print head; disposing an inductor at the other side of the ink print workbench, a printed face of an obverse side of the canvas facing to the inductor; collecting image data of the printed face by the inductor during conveying the canvas and transmitting the image data to a signal processing device to process, and after time sequence processing, determining print positions on the unprinted face depending on results of the processing; and driving the print head to print on the determined print positions on the unprinted face by a print driving device, for achieving the double-faced ink print on the canvas for the advertising light boxes.

### CROSS-REFERENCE TO RELATED APPLICATIONS

This application is a continuation of International Patent Application No. PCT/CN2007/000317 with an international filing date of Jan. 29, 2007, designating the United States, now pending. The contents of all of the aforementioned applications, including any intervening amendments thereto, are incorporated herein by reference.

### BACKGROUND OF THE INVENTION

1. Field of the Invention

The present invention relates to manufacturing advertising light boxes, and more especially to a process and apparatus for double-face ink-printing canvases for advertising light boxes.

2. Description of the Related Art

To ensure display effects of advertising light boxes by day and at night, inner sides of canvases for the advertising light boxes always are repeatedly ink-printed a color layer on to complement colors, so that the ink-printed pictures are more brightly colorful and saturated. It is very important for advertising light box goods.

At present, there are three ways to ink-print mirror pictures on reverse sides of the canvases which coincide with pictures on obverse sides of the canvases:

A) gluing two single-facedly ink-printed canvases with the same picture, respectively;

B) adopting technologies of ink-printing on two sides of a canvas at the same time, such as the technology disclosed in PCT/CN2004/000121;

C) while ink-printing on an obverse side of a canvas, printing positioning mark lines around a picture on the canvas; and while ink-printing a mirror picture on a reverse side of the canvas, constantly rectifying the position of the canvas or a print point by artificial correction or by an inductor inducing the positioning mark lines, to make the ink-printed picture on the reverse side of the canvas coincide with the ink-printed picture on obverse side of the canvas.

In the above three ways, to the way A), because it needs very high precision to achieve the ink print, the ink print of the canvas is difficult to operate, light transmission ratio of the ink-printed picture is lower, and the manufacture cost is too high, the way A) is seldom used at present. To the way B), because it needs two sets of nozzles to work at the same time, the cost of ink print devices is too high. Furthermore, because channels for drying printing ink on the pictures are limited in the ink print devices and short, the drying speed is limited in a lower speed for preventing the pictures from adhering after the two sides of the canvas are ink-printed at the same time, and the rate of production is limited. The way C) is a common ink print way. However, the canvas is easy to produce irregular deformation during the ink print. For example, heating or deformation of rollers of an ink print machine causes the canvas to deform, so that even if two edges of the canvas align with each other during the canvas being rolled up, it cannot ensure that a middle portion of the canvas keeps its shape and maintains a correct position. Especially to wide canvases, the errors are bigger. Besides, that the canvas is out of place will cause the picture to produce ghost images. Basing on strict demands on the canvases for advertising light boxes, even if there are a few errors on the canvases, the canvases are abandoned. So the way C) brings waste of manpower and material resources and holds up technology progress.

### SUMMARY OF THE INVENTION

An object of the present invention is to provide a process and apparatus for double-face ink-printing canvases for advertising light boxes which ensures that double-face ink-printed pictures on a canvass can align with and coincide with each other, and avoids complicated aligning operations in the process of ink-printing an unprinted face of a reverse side of the canvas. The present invention effectively solves the problem to align mirror pictures on reverse sides of canvases in the process of double-faced ink print.

At first, assuming that the direction of a reciprocating movement of a nozzle in the ink print apparatus is X-direction, the direction in which a canvas moves is Y-direction. The X-direction and the Y-direction always are perpendicular to each other.

To achieve the above-mentioned object, a process for double-face ink-printing a canvas for advertising light boxes in accordance with the present invention is disclosed. The process includes: disposing a print head 3 at a side of an ink print workbench 1, an unprinted face 21 of a reverse side of the canvas facing to the print head 3; disposing an inductor 4 at the other side of the ink print workbench 1, a printed face 22 of an obverse side of the canvas facing to the inductor 4; collecting image data of the printed face 22 of the obverse side of the canvas by the inductor 4 in the process of conveying the canvas 2 and transmitting the image data to a signal processing device 5 to process, and after time sequence processing, determining print positions on the unprinted face 21 of the reverse side of the canvas depending on results of the processing; and driving the print head 3 to print on the determined print positions on the unprinted face 21 of the reverse side of the canvas by a print driving device 6, for achieving the double-faced ink print on the canvas for the advertising light boxes.

The present invention further provides an apparatus for double-face ink-printing a canvas for advertising light boxes. The apparatus includes a print head 3 disposed at a side of an ink print workbench 1; a print driving device 6 driving the print head 3; an inductor 4, disposed at the other side of the ink print workbench to induct and collect image data of a printed face 22 of an obverse side of the canvas; and a signal processing device 5, connecting with the inductor 4; wherein the signal processing device 5 determines print positions on an unprinted face 21 of a reverse side of the canvas depending on results of time sequence processing and the print driving device 6 drives the print head 3 to print on the determined print positions on the unprinted face 21 of the reverse side of the canvas.

Advantageously, the print action of the print head 3 is performed in synchronization with the collect action of the inductor 4.

Advantageously, the inductor 4 is horizontally disposed in a direction of width of the whole canvas.

Advantageously, the print head 3 is a color print head.

Advantageously, the inductor 4 is a color inductor 41.

Advantageously, the color inductor 41 is a strip-shaped CCD color inductor 411 or an inductor formed by connecting a plurality of strip-shaped CCD color inductors 412.

Advantageously, the signal processing is converting RGB signals into CMYK four-color signals.

The efficacy of the present invention is as follows:

1) Comparing with the conventional way B, the present invention only needs a set of nozzle, so the cost is lower and it is convenient for maintenance. Furthermore, it doesn't need a special drying process, thereby achieving a high-speed printing process.

2) The present invention simplifies conventional double-faced ink print technologies and avoids the displacement of the pictures caused by the deformation of the canvases. Comparing with the conventional way C, the present invention avoids waste and reduces the loss and manufacture risk.

3) The present invention is easy to achieve and convenient for operation and maintenance. The present invention has a low cost.

### BRIEF DESCRIPTION OF THE DRAWINGS

The invention is described hereinafter with reference to accompanying drawings, in which:

FIG. 1 is a schematic illustration showing double-face ink-printing a canvas for an advertising light box in accordance with the present invention;

FIG. 2 shows a way of dynamic scan in the X-direction;

FIG. 3 shows a way of static scan in the X-direction; and

FIG. 4 shows an arrangement way of a plurality of strip-shaped color inductors.

### DETAILED DESCRIPTION OF THE EMBODIMENTS

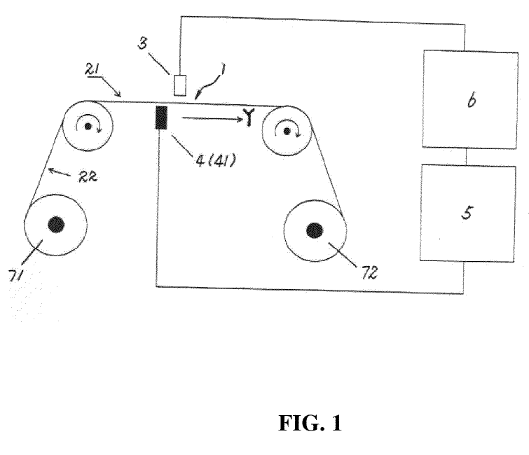

FIG. 1 is a schematic illustration showing double-face ink-printing a canvas for advertising light boxes in accordance with the present invention. A print head 3 is disposed at a side of an ink print workbench 1 and an unprinted face 21 of a reverse side of the canvas faces to the print head 3. An inductor 4 is disposed at the other side of the ink print workbench 1 and a printed face 22 of an obverse side of the canvas faces to the inductor 4. The canvas 2 is rolled up and put in a closing cloth roller 71 and an opening cloth roller 72. In the process of conveying the canvas 2, when the picture passes by a print area of the ink print workbench 1, the inductor 4 collects image data of the printed face 22 of the obverse side of the canvas and then transmits the image data to a signal processing device 5 to process. After time sequence processing, print positions on the unprinted face 21 of the reverse side of the canvas are determined depending on the results of the processing, and then a print driving device 6 drives the print head 3 to print on the determined print positions, thereby achieving the double-faced ink print on the canvas for the advertising light boxes.

The above time sequence processing can ensure that the printed picture coincides with the picture on the other side completely.

There are mainly two ways to achieve the above double-faced ink print, which are as follows:

### Embodiment 1

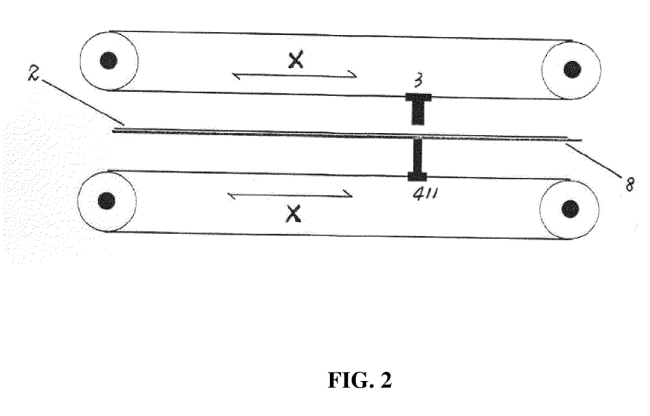

As shown in FIG. 2, the inductor 4 is disposed in the X-direction of the reciprocating movement of a nozzle in the ink print apparatus. In the way that the inductor 4 moves dynamically, when the canvas is conveyed in Y-direction, the inductor 4 collects image data of the printed face 22 of the obverse side of the canvas.

Specifically, a panel 8 made of transparent glass is arranged in front of and below the workbench of the ink print apparatus, and a strip-shaped CCD color inductor 411, which moves in synchronization with the print head, is arranged under the panel 8 made of transparent glass. During the movement of the strip-shaped CCD color inductor 411, an illuminative light illuminates the picture to ensure signal intensity and accuracy of color induction.

Color scan is always performed in front of the print area, so there is enough time to process the collected color data. The processing includes converting RGB signals into CMYK signals to form four-color print buffer sequences, and under control of print time sequences, printing on the canvas in ink with corresponding color in the way that the first item to be retrieved is the one stored earliest by the print head 3.

To ensure that the printed picture coincides with the picture on the obverse side, the color signals collected by the color inductor 41 are delayed and printed depending on the time sequences that the printer conveys the canvas and the nozzle moves.

An advantage of the way of dynamic scan in the X-direction is that only an inductor is used, so the problem that the color signals aren't uniform does not exist and it is more convenient for processing the signals.

### Embodiment 2

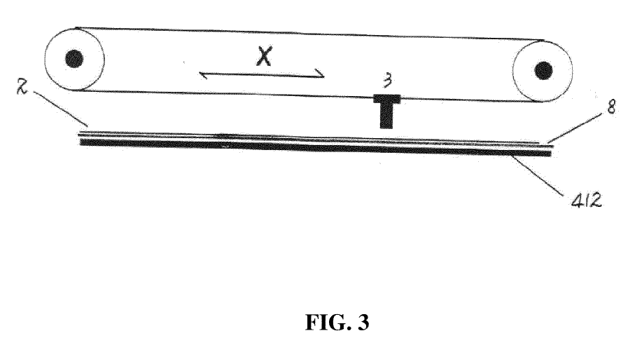

As shown in FIG. 3, the inductor 4 is disposed in the X-direction of the reciprocating movement of a nozzle in the ink print apparatus. In the way that the inductor 4 is fixed statically, when the canvas is conveyed in Y-direction, the inductor 4 collects image data of the printed face 22 of the obverse side of the canvas.

Specifically, a panel 8 made of transparent glass is arranged in front of and below the workbench of the ink print apparatus, and a strip-shaped CCD color inductor 411, which has the same width with the unprinted face of the canvas, is arranged under the panel 8 made of transparent glass. While the strip-shaped CCD color inductor 411 works, an illuminative light illuminates the picture to ensure signal intensity and accuracy of color induction.

Color scan is always performed in front of the print area, so there is enough time to process the collected color data. The processing includes converting RGB signals into CMYK signals to form four-color print buffer sequences, and under control of print time sequences, printing on the canvas in ink with corresponding colors in the way that the first item to be retrieved is the one stored earliest by the print head 3.

To ensure that the printed picture coincides with the picture on the obverse side, the color signals collected by the color inductor 41 are delayed and printed depending on the time sequences that the printer conveys the canvas and the nozzle moves.

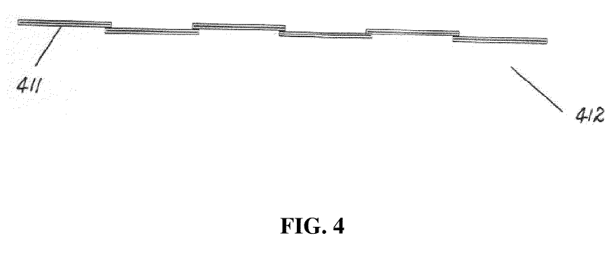

Considering that length of the strip-shaped CCD color inductor 411 is less than print width of the printer in practical production, it needs to arrange and connect a plurality of in-line strip-shaped CCD color inductors 411 in the way as shown in FIG. 4. Then an inductor 412 formed by seamlessly connecting the plurality of inductors 411 is controlled by software. Since the plurality of inductors 411 are used, the gain of every inductor 411 needs to be adjusted. Further, the gain of every inductor 411 can be adjusted to a same value via scanning preprinting strips on the picture under control of software.

An advantage of the way of static scan in the X-direction as shown in FIG. 3 is that it is unnecessary to dispose an additional set of control system, so the apparatus has a sample structure. Of course, the color signals need to be adjusted to be uniform by software for being effectively controlled.

### INDUSTRIAL PRACTICALITY

Because the pictures on the reverse sides of the canvases only have a function of complementary colors, quality requirements on the pictures on the reverse sides of the canvas are not so strict as those on the pictures on the obverse sides. So it is unnecessary to adopt conventional technologies to print mirror pictures depending on image files on obverse sides of the canvases, and the present invention can achieve double-faced and coincident ink print. The present invention avoids complicated aligning operations in the process of ink-printing unprinted faces of reverse sides of the canvases and effectively solves the problem to align mirror pictures on the reverse sides of the canvases in the process of double-faced ink print.

What are disclosed above is only the preferred embodiments of the present invention and it is therefore not intended that the present invention be limited to the particular embodiments disclosed. It will be understood by those skilled in the art that various equivalent changes may be made depending on the specification and the drawings of present invention without departing from the scope of the present invention.

The invention claimed is:

1. A process for double-face ink-printing a canvas for advertising light boxes, comprising:
disposing a print head at a side of an ink print workbench, an unprinted face of a reverse side of the canvas facing to the print head;
disposing an inductor at the other side of the ink print workbench, a printed face of an obverse side of the canvas facing to the inductor;
collecting image data of the printed face of the obverse side of the canvas by the inductor in the process of conveying the canvas and transmitting the image data to a signal processing device to process, and after time sequence processing, determining print positions on the unprinted face of the reverse side of the canvas depending on results of the processing; and
driving the print head to print on the determined print positions on the unprinted face of the reverse side of the canvas by a print driving device, for achieving the double-faced ink print on the canvas for the advertising light boxes.

2. The process as claimed in claim 1, wherein the print action of the print head performed in synchronization with the collect action of the inductor.

3. The process as claimed in claim 1, wherein the inductor is horizontally disposed in a direction of width of the canvas.

4. The process as claimed in claim 1, wherein the print head is a color print head.

5. The process as claimed in claim 1, wherein the inductor is a color inductor.

6. The process as claimed in claim 5, wherein the color inductor is a strip-shaped CCD color inductor or an inductor formed by connecting a plurality of strip shaped CCD color inductors.

7. The process as claimed in claim 1, wherein the signal processing is converting RGB signals into CMYK four-color signals.

8. An apparatus for double-face ink-printing a canvas for advertising light boxes, comprising:
a print head, disposed at a side of an ink print workbench;
a print driving device; driving the print head;
an inductor, disposed at the other side of the ink print workbench to induct and
collect image data of a printed face of an obverse side of the canvas; and
a signal processing device, connecting with the inductor;
wherein the signal processing device determines print positions on an unprinted face of a reverse side of the canvas depending on results of time sequence processing and the print driving device drives the print head to print on the determined print positions on the unprinted face of the reverse side of the canvas.

9. The apparatus as claimed in claim 8, wherein the print action of the print head is performed in synchronization with the collect action of the inductor.

10. The apparatus as claimed in claim 8, wherein the inductor is horizontally disposed in a direction of width of the canvas.

11. The apparatus as claimed in claim 8, wherein the print head is a color print head.

12. The apparatus as claimed in claim 8, wherein the inductor is a color inductor.

13. The apparatus as claimed in claim 12, wherein the color inductor is a strip-shaped CCD color inductor or an inductor formed by connecting a plurality of strip-shaped CCD color inductors.

14. The apparatus as claimed in claim 8, wherein the signal processing is converting RGB signals into CMYK four-color signals.
